(19) United States
(12) Patent Application Publication
(10) Pub. No.: US 2026/0014917 A1
(43) Pub. Date: Jan. 15, 2026

(54) ELECTRIC FOLDING TABLE ARRANGEMENT FOR A VEHICLE INTERIOR

(71) Applicants: Inteva Products, LLC, Troy, MI (US); Inteva Products Europe GmbH, Solingen (DE)

(72) Inventors: Niklas Kock, Sprockhoevel (DE); Andreas Rahn, Radevormwald (DE); Stefan Wiepen, Schwerte (DE)

(21) Appl. No.: 19/268,574

(22) Filed: Jul. 14, 2025

(30) Foreign Application Priority Data
Jul. 15, 2024 (DE) 10 2024 120 185.1
Oct. 21, 2024 (DE) 20 2024 106 040.7

(51) Int. Cl. B60N 3/00; B60R 11/00

(52) U.S. Cl. CPC B60N 3/001; B60R 11/00; B60R 2011/0082; B60R 2011/0084; B60R 2011/0089; B60R 2011/0092

(57) ABSTRACT

A folding table arrangement, including: a base carrier; a support arm assembly coupled to the base carrier and having a support arm which is pivotally mounted about a first pivot axis and pivotable between a retracted position and an extended position; and a table top assembly coupled to the support arm and pivotally arranged relative to the support arm about a second pivot axis different from the first pivot axis, wherein the table top assembly is pivotable between a folded position and an unfolded position, the table top assembly including a holding arm hinged to the support arm and a table top rotatably mounted on the holding arm about a rotational axis different from the first pivot axis and the second pivot axis, and wherein the table top assembly is assigned a drive device which has a motor device for driving and controlling the pivoting movement of the table top assembly about the second pivot axis relative to the support arm, wherein the drive device comprises a spindle drive device and the spindle drive device is mounted on the support arm so that it is pivotable together with the support arm.

### CROSS REFERENCE TO RELATED APPLICATIONS

This application claims priority under 35 U.S.C. § 119 to the following German Patent Application No. 10 2024 120 185.1, filed on Jul. 15, 2024, and German Utility Model Patent Application No. 20 2024 106 040.7, filed on Oct. 21, 2024 the entire contents each of which are incorporated herein by reference thereto.

### BACKGROUND

The present disclosure relates to an electrically operated folding table arrangement. In particular, the present disclosure relates to an electrically operated folding table arrangement that can be flexibly used for different applications, including the automotive industry, furniture industry, and others. In a preferred application, the electrical folding table arrangement is designed for an interior, e.g., of a motor vehicle, aircraft, or railway vehicle, so that it can be installed on a seat arrangement of the vehicle and can be used comfortably by a person sitting on a seat of the seat arrangement when the vehicle is in operation. In another preferred application, the electric folding table arrangement can be used as table furniture in the home, in offices, workshops, in the catering industry or even in outdoor areas.

Particularly in the case of motor vehicles, there is an increasing desire among automotive customers for greater flexibility and adaptability of the vehicle interior, so that vehicles must be provided to meet wider customer requirements. For example, longer journeys and the amount of time spent in a vehicle have led to consumers increasingly demanding vehicle interiors that allow for activities such as working, playing or eating. Table top assemblies located in the vehicle can be used for this purpose.

Such table top assemblies are particularly suitable for rear passengers of motor vehicles and may, for example, be installed in a rear seat console between a left and right seat of a rear seat arrangement. Preferably, such table arrangements can be folded into and stowed in a storage space and only unfolded or folded out into their functional position when required. Table top assemblies may also be desired for the driver or front passenger. For example, with increasing semi-autonomous or assisted driving of a vehicle, a driver will increasingly have times when they have fewer driving tasks to perform and can therefore devote themselves to secondary activities for which the presence of a table is sometimes helpful. As a result, there is a growing need for folding table arrangements that can be folded in and stowed away or unfolded and used as required. In addition to user comfort, easy and flawless operability, robustness and durability as well as attractive aesthetics are the main requirements for such folding table arrangements.

Such flexible folding table arrangements may also be desirable or indispensable for increasing comfort in rail vehicles or aircraft, particularly in higher classes of transportation, e.g. in first class railroad carriages or in the business class or first class of an aircraft, or in furniture or furnishing areas where quick and easy folding and stowing of table arrangements is desired or necessary to save space or for aesthetic reasons.

DE 10 2015 226 812 A1 describes a folding table arrangement that is installed in a console compartment of a rear seat console of a vehicle, which is equipped with an armrest for pivotably closing the console compartment. The folding table can be pulled out of the console compartment via a rotating arm when the armrest is unfolded, whereupon a table top can be unfolded and rotated into a desired position. The position of the folding table can be adjusted to the position of a vehicle occupant sitting to the left or right of the rear seat console. When not in use, the folding table arrangement can be folded up again, pushed into the console compartment by rotating the rotating arm and stored in the compartment so that it is invisible from the outside.

Although the known folding table arrangement can provide the necessary comfort for passengers and offers good functionality, the folding table arrangement can be difficult to operate or handle. A passenger wishing to use the table arrangement must be familiar with the process of pulling out and unfolding the table from the console compartment into the use position and the reverse process of folding and stowing the table in the console compartment in order to avoid operating errors and possible damage to components of the folding table arrangement, on the one hand, and to minimize the risk of injury when operating the folding table arrangement, on the other hand. In addition, it can be cumbersome for a rear seat passenger to align themselves with the rear seat console, unfold the armrest, grasp the folding table arrangement and apply sufficient force to it to pull the folding table arrangement out of the console compartment, then unfold and rotate it to the desired position or stow the folding table arrangement again. A coil spring can be provided to provide a restoring force that preloads the rotating arm to assist in unfolding the table arrangement. However, the user must then apply additional force to overcome the restoring force of the coil spring in order to stow the table arrangement.

The co-pending German patent application with the application number DE 10 2023 117 792.3, filed on Jul. 6, 2023, which belongs to the applicant of the present patent application, describes a folding table arrangement for a motor vehicle with a base carrier, a support arm assembly coupled to the base carrier, which has a support arm which is pivotally mounted about a first pivot axis and which can be pivoted between a retracted and an extended position, and a table top assembly coupled to the support arm, which can be pivoted relative to the support arm about a second pivot axis different from the first pivot axis between a folded and an unfolded position. The table top assembly has a holding arm hingedly connected to the support arm and a table top which is rotatably mounted on the holding arm about a rotational axis different from the first pivot axis and the second pivot axis. Each of the first and second pivot axes and the rotational axis is assigned a separate drive device with a respective motor device for driving and controlling the pivotal movement of the support arm relative to the base carrier, the pivotal movement of the table top assembly relative to the support arm, and the rotational movement of the table top relative to the support arm.

Thus, the setting up and stowing of the folding table arrangement can advantageously be fully automated and controlled by the three drive devices. However, the drive devices require a relatively large amount of installation space and are relatively complex. For example, the drive device for extending and retracting the support arm comprises a worm gear motor with a first motor and a worm gear on the motor side, a drive shaft, another worm gear on the support arm side, which is drivingly connected to the worm gear motor via the drive shaft, and further power transmission elements, which serve to convert a rotational movement of the first motor into a pivotal movement of the support arm. The space required, the complexity, the weight, the number of parts and the costs for manufacture and assembly can be relatively high.

The drive device for folding and unfolding the table top assembly comprises a threaded spindle drive and a support arm, which operate in combination to convert a rotational movement of the threaded spindle drive motor into a folding or unfolding movement of the table top assembly relative to the support arm about the second pivot axis. The threaded spindle drive is attached to the support arm, so that a relatively large amount of space must be provided for the second drive device in the support arm, and the overall weight of the table top assembly can be relatively high. Consequently, the second drive device must be dimensioned to pivot the relatively high inertial mass of the table top assembly, which may further increase the space required in the support arm and the weight in the table top assembly.

There is a desire for improved drive devices for an at least partially electrically operated folding table arrangement in order to reduce the space requirements and complexity, reduce the moving masses and torques, and enable stable, safe, and quiet operation of the folding table arrangement. Furthermore, it has also been determined that not all movements of the folding table arrangement may need to be electrically operated and motor-controlled, so that flexible electrically operated folding table arrangements are required, which can comprise different drive devices as needed.

### BRIEF SUMMARY

Based on this, the object of the present disclosure is to provide a folding table arrangement that offers easy handling and comfort for the user. Preferably, the folding table arrangement should be easy to set up and store, flexible in use, robust and durable, and have a relatively simple, aesthetically designable structure with the lowest possible heavy and inert mass, reduced space requirement, and reduced complexity.

To achieve this object, according to the present disclosure, a folding table arrangement is provided, which comprises: a base carrier; a support arm assembly coupled to the base carrier and having a support arm which is pivotally mounted about a first pivot axis and can be pivoted between a retracted position and an extended position; and a table top assembly coupled to the support arm and pivotally arranged relative to the support arm about a second pivot axis different from the first pivot axis, wherein the table top assembly is pivotable between a folded position and an unfolded position, wherein the table top assembly comprises a holding arm hinged to the support arm and a table top which is rotatably mounted on the holding arm about a rotational axis different from the first pivot axis and the second pivot axis. The table top assembly is assigned a drive device which has a motor device for driving and controlling the pivoting movement of the table top assembly about the second pivot axis relative to the support arm, wherein the drive device comprises a spindle drive device and the spindle drive device is mounted on the support arm so that it is pivotable together with the support arm.

The present disclosure provides a motorized drive device for pivoting the table top assembly relative to the support arm. With the drive device, the table top assembly can be automatically pivoted or folded about the second pivot axis between a folded position and an unfolded position and vice versa in both directions of the folding movement. This movement of the table top assembly requires no force at all and no assistance from the user. The user can control the processes easily, quickly and conveniently using a controller, e.g. by pressing the corresponding buttons on a control panel, a remote control or other means. The extension and retraction of the support arm assembly about the first pivot axis and/or the rotation of the table top to the desired position about its pivot axis can be performed manually or by motor operation, depending on the desired degree of automation and configuration of the folding table arrangement. In any case, handling is simplified and the risk of operating errors with associated risks of damage to the folding table arrangement, the surroundings and the operator is reduced. The folding table arrangement is particularly well suited for use in the interior of a vehicle, e.g., a motor vehicle, aircraft, or railway vehicle, or as a piece of furniture in indoor and outdoor areas.

Advantageously, the spindle drive device is attached to the support arm and can be pivoted together with it. The components of the spindle drive device can be suitably distributed on the support arm so that their mass fractions on both sides of the second pivot axis can at least partially compensate each other and the resulting center of mass is relatively close to the second pivot axis of the support arm in order to reduce the lever arm. Only small forces need then be used to retract and extend the support arm with the spindle drive device. When folding the table top assembly, the spindle drive unit is not moved at all, so that comparatively low torques or drive forces of the drive unit are sufficient for the folding movement of the table top assembly. If the spindle drive device were mounted on the support arm of the table top assembly, the spindle drive device would have to be pivoted both when extending and retracting the support arm and when folding and unfolding the table top assembly. In this respect, the drive unit with the spindle drive unit can be designed for relatively low torques or power, which also reduces its weight and installation space.

In an advantageous embodiment, the spindle drive device comprises a motor, in particular an electric direct current motor, which is part of the motor device, a threaded spindle driven in rotation by the motor and a spindle nut which cooperates with the threaded spindle in order to convert a rotational movement of the threaded spindle into a linear movement of the spindle nut. In addition, the spindle drive device is operatively coupled between the holding arm and the support arm in such a way that a linear movement of the spindle nut is converted into a pivotal movement of the table top assembly about the second pivot axis relative to the support arm. A simple, robust and efficient linear drive can be provided to realize the pivoting movement.

In a particularly advantageous embodiment, the motor is attached to the support arm, the threaded spindle is rotatably mounted on the support arm and the spindle nut is non-rotatably connected to the support arm and is displaceably mounted relative to the support arm, wherein the spindle nut is furthermore operatively coupled to the holding arm of the table top assembly in order to pivot it as a result of its linear movement. The essential components of the drive device, in particular the spindle drive device, can thus be very conveniently held and positioned on the support arm in order to minimize the required torques and drive power.

In the aforementioned preferred embodiment, the drive device preferably further comprises a supporting beam which is connected at one end to the support arm via a joint so as to be relatively pivotable and displaceable, wherein the supporting beam is drivingly connected via the joint to the spindle nut so as to be displaced by the latter along the support arm. At its other end, the supporting beam is further hinged to the holding arm of the table top assembly via a further joint. When the motor of the motor device rotates, the spindle nut runs over the threaded spindle and thus takes the first end of the supporting beam with it, whereby the table top assembly is folded or unfolded through the action of the other end of the supporting beam. During the unfolding movement and in particular in the unfolded position, the table top assembly is securely and stably supported against the support arm by the supporting beam.

Preferably, the motor of the motor device can be arranged to switch off if predetermined maximum motor current limits are exceeded when end positions are reached at which the spindle nut is prevented from being moved further linearly. The motor therefore runs until it reaches the respective end position and switches off via the current limit. Anti-pinch protection can also be implemented on the basis of a maximum current limit.

In order to increase safety, in advantageous embodiments, a switch can be arranged and configured in such a way that it is actuated when the table top assembly is in an unfolded position. When the switch is actuated, the table can then be prevented from retracting in the unfolded position, for example. A mechanical switch or an electrical or electronic switch can be provided. Various switches, such as contact switches, reed contacts, Hall sensors and the like, can be used for this purpose. Other electrical, magnetic, or optical sensors can also be used to detect the end position.

In principle, the support arm assembly can be arranged to be pivoted manually relative to the base carrier between a retracted and an extended position. In the fully retracted position, the support arm and the folding table arrangement as a whole can, for example, be stowed in a storage space of a vehicle, e.g. in a storage space of a rear seat console of a rear seat arrangement of a motor vehicle, or a housing. In the fully extended position, the support arm and the folding table arrangement as a whole protrude, for example, out of the storage space and, for example, essentially vertically upwards from the base carrier.

In an advantageous further development of the present disclosure, the support arm assembly can also be assigned a further drive device which has a further motor device and a gear transmission device drivingly connected to the further motor device for driving and controlling the pivoting movement of the support arm about the first pivot axis relative to the base carrier. In this way, the support arm assembly can be moved additionally motor-assisted, automatically from a fully retracted position stowed in a storage space to a position extended from the storage space and vice versa. The extension and retraction movements of the support arm assembly and the folding movements of the table top assembly then require no force at all and no assistance from the user. All of these movements can be achieved easily, quickly and conveniently via a controller, e.g. a control panel, remote control or similar. Handling is further simplified and the risk of operating errors and damage is further minimized.

It can be advantageous if the additional motor device is designed as a worm gear motor with an additional motor, in particular a direct current motor, and a preferably self-locking worm gear. With its space-saving design, the worm gear motor is well suited for high torques at low speeds and can provide the appropriate transmission ratio in the drive train of the additional drive device. Worm gear motors can withstand high loads and also impress with their high efficiency, quiet and relatively vibration-free, smooth running and long service life, which makes them particularly suitable for the present application. The worm gear is preferably specifically designed to be self-locking in order to enable stepless tilt adjustment and to be able to maintain a stable position of the support arm assembly with the table top relative to the support arm in any desired inclined position of use and even when external force is applied. Without self-locking of the worm gear, means should be provided to prevent inadvertent pivoting of the support arm assembly out of the position of use when external force is applied.

In an advantageous embodiment, the gear transmission device can comprise a pinion driven by the first motor device and a gear element fixedly connected to the support arm, which meshes with the pinion. By using such a gear transmission device in the drive train between the further motor device and the support arm, a further drive device is provided which, on the one hand, enables reliable operation, high actuation accuracies and high gear ratios and, on the other hand, results in a very compact and low-complexity structure which requires few interacting parts, has a relatively low total weight and a low moving mass and reduces the space requirement. The further motor device can be mounted on the base carrier and held securely by the base carrier, wherein the base carrier can be designed for attachment to a vehicle floor, e.g. the body substructure or the floor below a seat in an aircraft, in particular an airplane, or in a railroad carriage.

Alternatively, the base carrier of the table furniture can be adapted for attachment to the floor of an installation area or in a housing in which the folding table arrangement is stowed.

In an advantageous embodiment, the gear drive device is designed as a spur gearing, with the pinion and the gear element being designed as preferably straight-toothed spur gears, both with external teeth. A straight-toothed spur gearing enables high efficiency with a very compact design. Other types of transmission, such as planetary gears, transmissions with Bowden cables or similar, are also possible in principle. However, these can increase the cost and complexity of the first drive unit, so that a spur gearing is preferable for this reason and also because of its reliability and durability.

Irrespective of the specific design of the gear transmission device, it can be particularly advantageous if the gear transmission device is designed as a single-stage transmission and enables a transmission to slow speed. This results in a simple, inexpensive and lightweight construction with few moving parts, which offers high rigidity and is capable of transmitting high power. The transmission ratio to low speed corresponds to a transmission ratio greater than 1. The single-stage gear transmission according to the present disclosure, in particular the spur gearing, enables relatively high transmission ratios with a compact design. The transmission ratio can be more than 2, preferably even more than 3.

In order to provide such ratios in a very compact size, in particularly preferred embodiments of the present disclosure, the gear element of the gear transmission device is designed as a gear segment which does not cover the entire circumference of a gear, but only forms a section thereof. The gear segment can be limited by an angular range (the segment angle) which is greater than or equal to 90° and less than 120° in order to enable the support arm assembly to be extended and retracted. The angular range encompassed by the gear segment can preferably be less than 110° and particularly preferably even less than 100° in order to minimize the space requirement and the weight of the gear element.

Stop means can be provided, for example on the support arm or the gear element on the one hand and the base carrier on the other hand, which specify the desired end positions for the support arm or limit a pivoting range of the support arm around the first pivot axis by mechanical engagement. A travel path of the support arm around the first pivot axis between predetermined end positions of more than 90°, preferably 90° to 110°, particularly preferably about 100°, is provided. Any travel path, which can also be less than 90° or more than 110°, can be specified.

Preferably, the additional motor device is arranged to switch off if predetermined maximum current limits for the motor current are exceeded when end positions are reached. Such overcurrent protections are generally known and are often already integrated in an electric motor as motor protection devices to protect against thermal overload. Here, they are used to switch off in the end positions of the holding arm. Anti-pinch protection can also be realized via a maximum current limit. The end positions of the support arm can be detected using optical, magnetic or electrical sensors.

For a desired tilt adjustment of the table, e.g. by about 30° or similar, a stop means is generally not required. The self-locking of the worm gear motor is sufficient. If necessary, however, stop means can also be provided for this purpose.

It should be noted that the further drive device and the further motor device may also be referred to herein as a first drive device and a first motor device for ease of reference and understanding, because they are associated with the first pivot axis. Accordingly, the drive device and the motor device associated with the second pivot axis may also be referred to herein as a second drive device and a second motor device. However, the terms “first”, “second”, “third”, etc. used herein do not indicate any order or importance of the specified elements. Rather, they are used to distinguish one element from one or more other similar or identical elements and to facilitate reference. The description of a “second” element or a “third” element or the like does not in principle imply the presence of a “first” such element or both a “first” and a “second” such element or the like. For example, the first drive device is not necessarily required.

The rotation of the table top relative to the holding arm of the table top assembly can, in principle, be performed manually, so that the second drive device and the first drive device, if present, are sufficient to provide adequate operating comfort. In order to further facilitate operability and further increase comfort, the table top assembly can preferably further comprise a third drive device, which comprises a third motor device for driving and controlling the rotational movement of the table top about the rotational axis relative to the holding arm. In this case, the table top can also be rotated electrically or motor-operated.

In a preferred embodiment, the third drive device can comprise a third motor with a preferably self-locking worm gear. This allows the set rotational position of the table top to be maintained relatively stable.

Advantageously, a slipping clutch can be arranged in the power transmission path of the third drive device between the third motor device and the table top, in particular between the worm gear and the table top, in order to allow the table top to be rotated relative to the third motor device, in particular relative to a worm wheel of the worm gear, by an external force. If an external force with a certain minimum load is applied to the table top, the table top can be stopped or even rotated in the opposite direction to the direction of rotation of the third motor despite the operation of the third drive device, so that a passenger can be prevented from being injured during motor operation or in the event of an impact caused by a collision of the passenger and the table top. The slipping clutch also makes it possible to quickly adjust the rotary position of the table top by hand at any time. The slipping clutch can also be provided if the third drive device is omitted and the rotational movement of the table top is not electrically or motor-operated, but purely manual.

Although different embodiments of the slipping clutch are possible, in a particularly simple embodiment the slipping clutch has a damping device which preferably has at least one O-ring interposed between the third motor device and the table top, in particular between the worm wheel of the worm gear and the table top. Several O-rings can also be provided as a damping device. The third drive device, in particular the worm gear, is connected to the table top via the O-ring or O-rings in a sufficiently rotationally fixed manner so that the table top is safely entrained when the third motor and in particular the worm gear rotates. However, a user has the option of stopping or manually rotating the table top as required. This also provides protection against pinching.

In embodiments of the present disclosure, the third drive device can further comprise at least one end position switch, so that the table is rotated by the third motor via the worm gear until the motor switch for the end position is reached. The third motor then switches off automatically. If a passenger holds the table top, the third motor can be configured such that it only continues to rotate for a defined time and then switches off automatically. Preferably, an end position switch is assigned to each direction of rotation. Instead of the end position switches, limit sensors, e.g. optical, electrical or magnetic sensors, can also be provided.

Further advantageous embodiments of the present disclosure emerge from the claims, the following description of preferred embodiments and from the drawings.

### BRIEF DESCRIPTION OF THE DRAWINGS

The drawings depict non-limiting embodiments of the subject-matter of the present disclosure. Where possible, the same reference signs are used in all figures to designate the same parts or components, whereby, unless otherwise specified, the explanations apply accordingly to all figures. In the figures:

FIG. 1 is a perspective view of an embodiment of a folding table arrangement according to the present disclosure in a use position;

FIGS. 2a-2d are perspective views of the folding table arrangement of FIG. 1 in different positions between a retracted and folded position (FIG. 2a) and an extended, unfolded and rotated position (FIG. 2d), on a smaller scale compared to FIG. 1;

FIG. 3 is a plan view from the front of a section of the folding table arrangement of FIG. 1, illustrating an embodiment of a base carrier and a first drive device for a support arm assembly of the folding table arrangement;

FIG. 4 shows a section of the folding table arrangement of FIG. 1, illustrating the base carrier and the first drive device for the support arm assembly in the embodiment according to FIG. 3 and an embodiment of a second drive device for a table top assembly of the folding table arrangement, in a sectional cross-sectional view, cut through a support arm of the folding table arrangement;

FIG. 5 is a view of the folding table arrangement of the embodiment according to FIGS. 1-4 in an extended and unfolded position, further illustrating a table top assembly and an embodiment of a third drive device for rotating a table top of the table top assembly of the folding table arrangement, in a cross-sectional view, cut through the support arm and the table top assembly of the folding table arrangement;

FIG. 6 shows the table top assembly of the folding table arrangement according to the present disclosure of the embodiment according to FIG. 5 in a top view from below, illustrating the third drive device for the table top assembly of the folding table arrangement; and

FIG. 7 shows the table top assembly of the folding table arrangement according to the present disclosure, illustrating the third drive device for rotating the table top and further details of the folding table arrangement in an exploded view.

### DETAILED DESCRIPTION

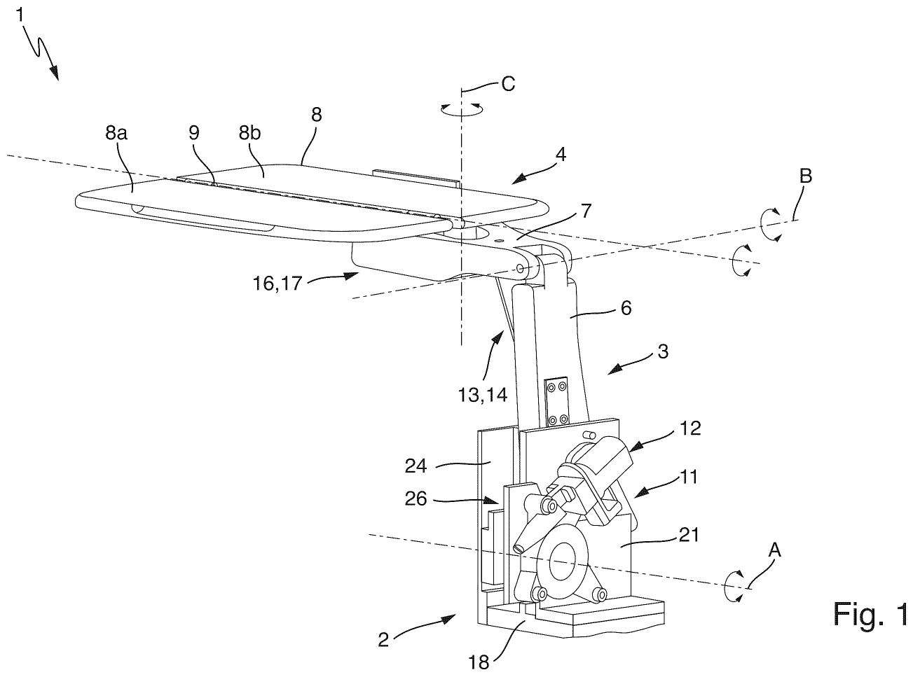

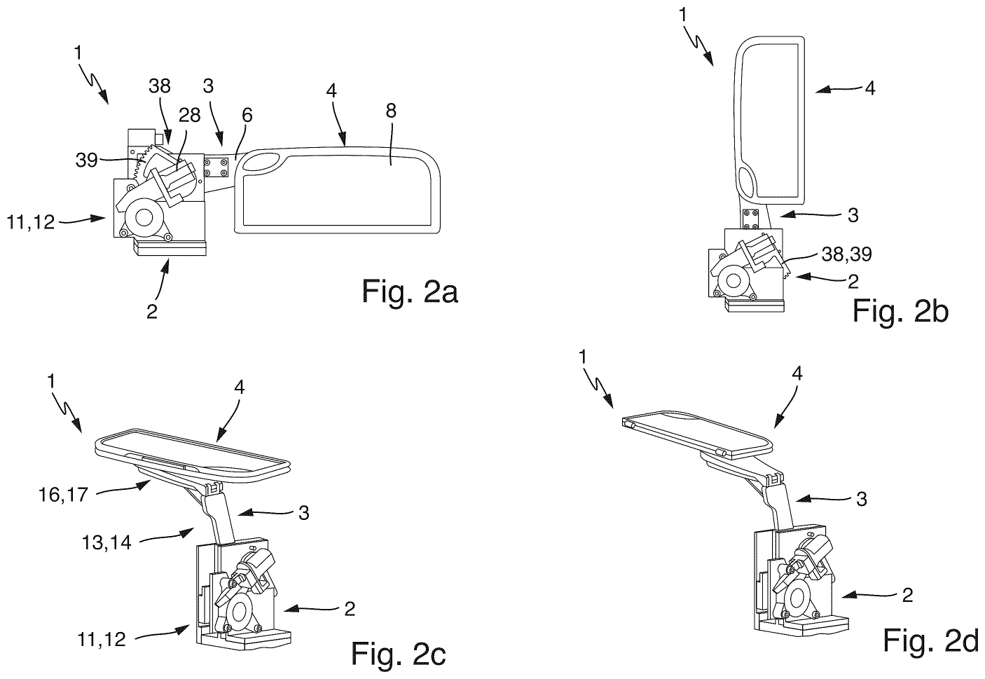

FIGS. 1 and 2a-2d show a folding table arrangement 1 according to the present disclosure for a vehicle interior, which is suitable for use as a foldable or collapsible table, particularly in situations where space is limited. The folding table arrangement 1 is also suitable for a vehicle interior for use in a motor vehicle and can be installed, for example, in a rear seat console of a motor vehicle in order to enable a user, a passenger or vehicle occupant sitting in the rear seat, to comfortably use the folding table arrangement. In principle, the folding table arrangement could also be designed for the front seats of a motor vehicle. It can also be used in other vehicles in which passengers are transported on seats, such as in aircraft, in particular airplanes, rail vehicles or ships. In FIG. 1, the folding table arrangement 1 is illustrated in a fully extended and unfolded use position, while FIGS. 2a-2d illustrate the folding table arrangement 1 in other positions.

According to FIG. 1, the folding table arrangement 1 comprises a base carrier 2, a support arm assembly 3 coupled to the base carrier 2 and a table top assembly 4 coupled to the support arm assembly 3. The support arm assembly 3 comprises a support arm 6 pivotally mounted about a first pivot axis A, which can be pivoted between a fully retracted position, as shown in FIG. 2a, and a fully extended position, as shown in FIG. 1 and in FIGS. 2b-2d. In the retracted position shown in FIG. 2a, the support arm assembly 3 is arranged in a horizontal position, with the table top assembly 4 spanning an essentially vertical plane and being coplanar, parallel to the support arm 6. In this position, the support arm assembly 3 and the table top assembly 4 can be accommodated, for example, in a storage space not shown here in detail, which is defined in the vicinity of the base carrier 2. In the extended position shown in FIG. 1 and FIGS. 2b-2d, the support arm assembly 3 with the table top assembly 4 projects substantially vertically upwards out of the storage space in order to support the table top assembly 4 at the top. A housing, not shown here, could be fitted around the base carrier 2 to define the storage space. The storage space could also be the interior of a rear seat console, for example.

The table top assembly 4 is arranged to be pivotable or foldable relative to the support arm 6 about a second pivot axis B, which is different from the first pivot axis A, so that the table top assembly 4 can be pivoted between a folded position and an unfolded position. In the folded position, as shown in FIGS. 2a and 2b, the table top assembly 4 is arranged substantially in line or coplanar with the support arm 6, whereas in the unfolded position, as shown in FIGS. 1, 2c and 2d, the table top assembly 4 is pivoted by substantially 90° relative to the folded position, so that the table top assembly 4 is aligned with its longitudinal extension or longitudinal direction substantially perpendicular to the support arm 6 and is arranged substantially horizontally overall. The second pivot axis B is aligned substantially perpendicular to the first pivot axis A, whereby the exact alignment of the second pivot axis B depends on the rotational position of the support arm assembly 3. Preferably, the first pivot axis A and the second pivot axis B lie in vertically offset horizontal planes in the use position according to FIG. 1.

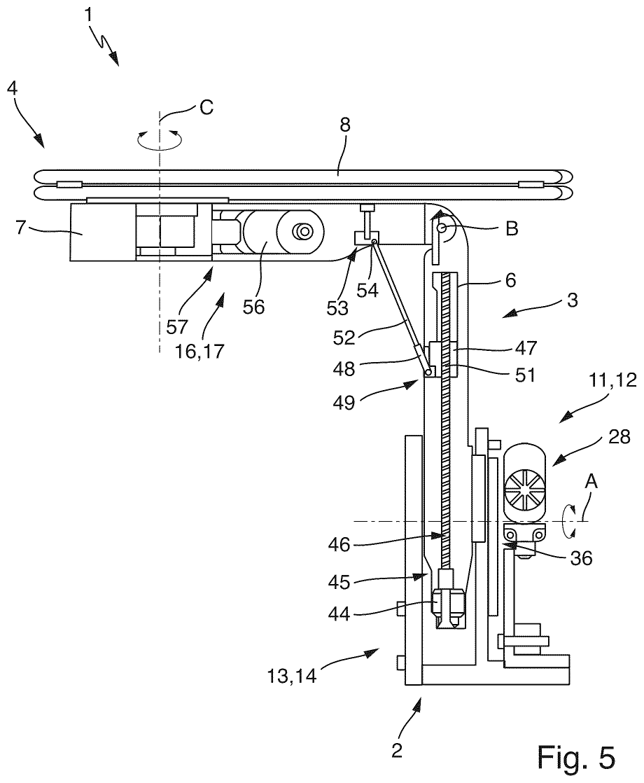

The table top assembly 4 further comprises a holding arm 7, which is largely concealed in FIG. 1 but shown in more detail in FIGS. 5-7 and which is hinged to the support arm 6, and a table top 8, which is mounted on the holding arm 7 so as to be rotatable about a rotational axis C which is different from the first pivot axis A and the second pivot axis B. In the fully extended and unfolded position shown in FIGS. 1, 2c and 2d, the rotational axis C is aligned perpendicular to the first pivot axis A and to the second pivot axis B and forms a vertical rotational axis. The pivot axis C can intersect the first pivot axis 1 or be slightly offset from it and is also offset from the second pivot axis B, arranged at a distance. However, the pivot axes A, B can be freely defined and do not have to be designed as in the embodiment example.

In the embodiment shown, the table top 8 is of divided construction and has a first table top half 8a and a second table top half 8b, which are pivotally connected to each other on their longitudinal sides by a hinge 9. The table top halves 8a, 8b can thus be optionally folded open, as illustrated in FIG. 1, to provide a table top 8 with a larger surface area, or they can be folded closed, as illustrated in FIGS. 2a-2d, to reduce the table surface area or to be stowed away in the storage space. Versions with a one-piece table top are also possible.

According to the present disclosure, the folding table arrangement 1 comprises at least one motor-assisted drive device which makes it possible to pivot at least one of the support arm assembly 3 and the table top assembly 4, preferably both. Preferably, a further motor-assisted drive device can also be provided in order to rotate the table top 8 into the desired position. The at least one motor-assisted drive device can assist the operator in operating the folding table arrangement 1 and transferring it from the retracted and folded, stowed starting position shown in FIG. 2a to at least a partially or even fully extended and unfolded use position, and vice versa. To simplify the description, the process of transferring the folding table arrangement 1 from the stowed starting position to the use position is also referred to as “setting up” the folding table arrangement 1, while the reverse process is also referred to briefly as “stowing” the folding table arrangement 1.

As can be seen from FIG. 1, the at least one drive device in the embodiment shown can include a first drive device 11, which is assigned to the support arm assembly 3 and has a first motor device 12 for driving and controlling the pivotal movement of the support arm 6 about the first pivot axis A relative to the base carrier 2. In the embodiment shown, the at least one drive device can also include a second drive device 13, which is assigned to the table top assembly 4 and has a second motor device 14 for driving and controlling the pivotal movement of the table top assembly 4 about the second pivot axis B relative to the support arm 6. In addition, the table top assembly 4 can have an optional third drive device 16, which is not visible in FIG. 1 but is shown in more detail in FIGS. 5-7 and which has a third motor device 17 for driving and controlling the rotational movement of the table top 8 about the rotational axis C relative to the holding arm 7.

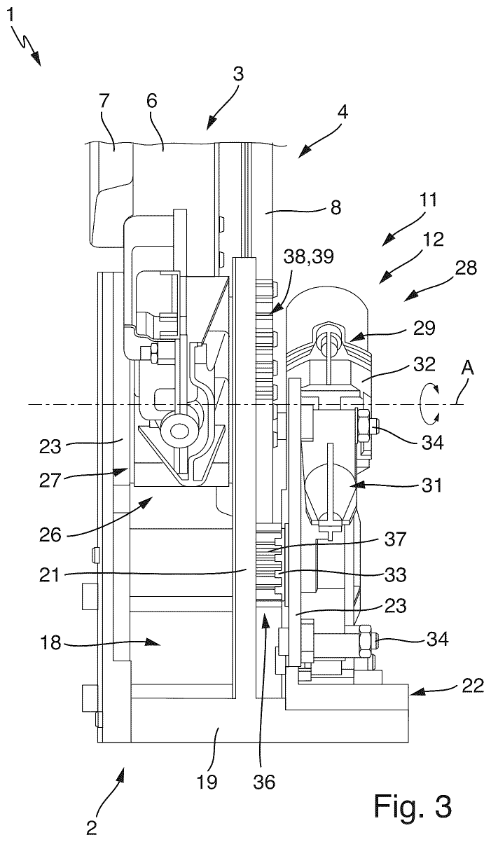

The components of the folding table arrangement 1 according to the present disclosure shown in FIG. 1 will now be explained in more detail with reference to FIGS. 3-7. Referring first to FIG. 3, the base carrier 2 and essential components of the first drive device 11 are shown therein. The base carrier 2 is designed here, for example, in several parts to facilitate manufacture and can have a base body 18 with a base plate 19, which is intended to be mounted on a floor of a vehicle, for example in a rear seat console of a motor vehicle, a floor under a seat in an aircraft or railroad carriage, or the floor of a housing or installation space, in order to fasten the folding table arrangement 1 and to hold it stable. The base body 18 can also have a bearing plate 21 protruding perpendicularly from the base plate 19, which serves to support the support arm assembly 3 and components of the first drive device 11.

A substantially L-shaped support element 22 can be attached to the base body 18, which has a vertically aligned support plate 23 that serves to attach the first motor device 12 of the first drive device 11.

Furthermore, in the embodiment shown, the base carrier 2 has a cover plate 24, which is arranged on a side of the base body 18 facing away from the support element 22 parallel to the bearing plate 21 and is fastened to the base body 18, so that a receiving space 26 for receiving a first end 27 of the support arm assembly 3 is formed between the cover plate 24 and the bearing plate 21. As FIG. 3 illustrates, the first end 27 of the support arm assembly 3 is accommodated in the receiving space 26 between the cover plate 24 and the bearing plate 21 in a protected manner and is rotatably mounted on an axis, which is not shown in detail here and which defines the first pivot axis A. The cover plate 24, the bearing plate 21 and the support plate 23 can be arranged such that they also provide a certain degree of protection against contact in order to prevent, as far as possible, a human hand from inadvertently reaching into the intermediate spaces and the moving parts of the support arm assembly 3 and the first drive device 11 located there, in particular when the folding table arrangement 1 is mounted in the storage space of a vehicle or a housing, which is not illustrated in detail here.

It should be understood that the embodiment of the base carrier 2 shown and described here is only exemplary and that the base carrier 2 can be designed in many different configurations in order to fulfill the function described here, in particular to stably support the folding table arrangement 1 and to securely fix it to a vehicle floor, for example in a storage space of a vehicle, a housing floor or directly on the floor of an installation space.

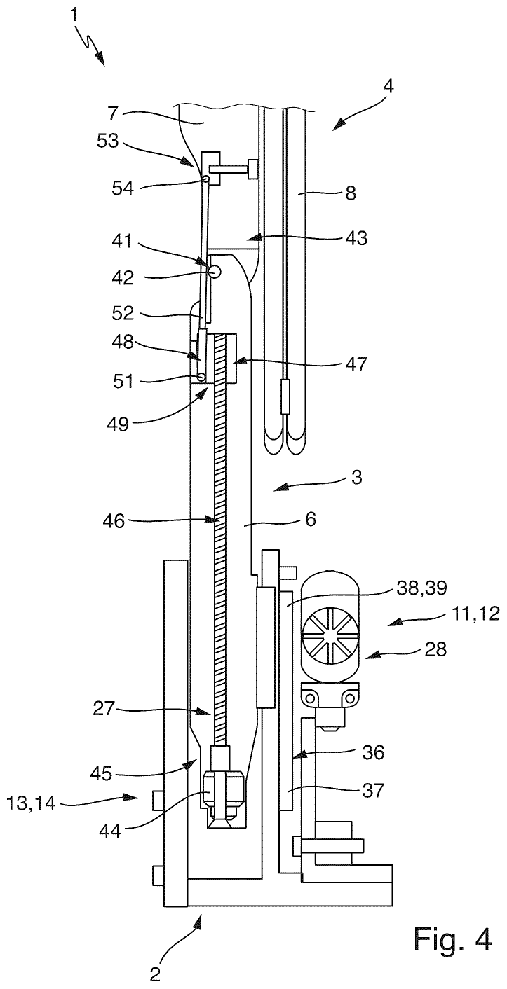

Referring in particular to FIGS. 3 and 4, the first motor device 12 of the first drive device 11 in the embodiment shown is advantageously designed as a worm gear motor 28 with a first motor 29, a direct current motor, and a preferably self-locking first worm gear 31. The worm gear motor 28 can deliver high torques at low speeds, withstand high loads and offer relatively quiet and vibration-free running, which is advantageous for the comfort applications envisaged here. It is robust and well suited for long-lasting operation. The first worm gear 31 in the worm gear motor 28 is preferably specifically designed to be self-locking, so that the support arm assembly 3 can be held securely in the desired use position and is not inadvertently pivoted about the first pivot axis A by external force.

Furthermore, as can be seen from the figures, the worm gear motor 28 is preferably provided as a finished assembly which is installed in a housing 32, so that only an output shaft 33 of the worm gear motor 28 shown in FIG. 3 is led out of the housing 32. The housing 32 of the worm gear motor 28 can, for example, be fastened to the support plate 23 of the base carrier 2 by means of screw bolts 34, while the output shaft 33 projects through an opening in the support plate 23, which is not visible in detail here.

Furthermore, as can be seen in particular from FIG. 3, the first drive device 11 also includes a gear transmission device 36, which converts the rotational movement of the output shaft 33 of the worm gear motor 28 into a pivotal movement of the support arm 6 about the pivot axis A relative to the base carrier 2. For this purpose, the gear transmission device 36 has a pinion 37, which is driven by the first motor device 12 by being non-rotatably connected to the output shaft 33 of the worm gear motor 28, and a gear element 38, which is directly fixedly connected to the support arm 6 and is in meshing engagement with the pinion 37.

In the preferred embodiment shown here, the gear transmission device 36 is designed as a spur gearing, whereby the pinion 37 and the gear element 38 are designed as straight-toothed spur gears. This enables high efficiency with a very compact design and little installation space. In the present example, the pinion 37 and the gear element 38 are both externally toothed spur gears, although alternatively the gear element 38 could also be designed as a ring gear with internal toothing that meshes with the external toothing of the pinion 37. Other types of gears, such as planetary gears, gears with Bowden cables and the like, could also be used, although a spur gear is preferred due to the low cost and installation space and the low complexity as well as high reliability and durability.

Advantageously, the gear transmission device 36 can be designed as a single-stage transmission with only the pinion 37 and the gear element 38, in order to enable a relatively high transmission ratio to the low speed with a very compact design. As is known, the transmission ratio is defined as the ratio of the number of teeth on the output gear to the number of teeth on the input gear and can also be determined approximately using the pitch diameters of the input and output gears. A transmission ratio to the low speed corresponds to a ratio greater than 1. The single-stage spur gearing according to the present disclosure enables relatively high ratios with a compact design. The transmission ratio can be more than 2. In the embodiment shown, it is even more than 3.

In order to provide such high ratios with a very compact size, the gear element 38 can be designed as a gear segment 39 which does not cover the entire circumference of a gear, but only forms a section of it. The gear segment 39 can be seen in particular in FIGS. 2a and 2b. It essentially covers an arc of a circle that is slightly larger than a quarter circle. More precisely, the gear segment 39 spans an angular range that is slightly larger than 90° and smaller than 120°. This angular range is sufficient for extending and retracting the support arm assembly 3. However, the angular range spanned by the gear segment 39 can be smaller than 110° and particularly preferably even smaller than 100° in order to minimize the space requirement and the weight of the gear element 38 as such and of the gear transmission device 36 as a whole.

When the worm gear motor 28 drives the output shaft 33 in rotation, the pinion 37, which is rotationally fixed to the output shaft 33, transmits the rotational movement via the meshing engagement with the gear segment 39 to the gear segment 39, which is consequently rotated about the first pivot axis A and pivots the support arm 6 about the first pivot axis A via the fixed connection to the first end 37 of the support arm assembly 3.

Means may be provided to specify the desired end positions for the support arm 6. For example, stop means may be provided on the support arm 6 or the gear element 38 on the one hand and the base carrier 2, e.g. the support plate 23, on the other hand, in order to specify the desired end positions for the support arm 6 and thus limit the pivoting range of the support arm 6 about the first pivot axis A by mechanical engagement. In any case, a travel path of the support arm 6 about the first pivot axis between the end positions of at least 90°, preferably 90° to 110°, and in particularly preferred embodiments of about 100° is provided. Depending on the design, a travel path of less than 90° may be sufficient or more than 110° may be required.

In addition or as an alternative to stop means, the first motor 29 of the worm gear motor 28 could also be configured in such a way that it switches off if predetermined maximum current limits of the motor current are exceeded when end positions are reached at which the output shaft 33 is prevented from continuing to run. The reaching of the end positions of the support arm 6 can also be detected by means of sensors, e.g. Hall sensors, optical sensors, electrical sensors or the like, and the first motor 29 can then be caused to switch off by a controller not shown in detail here. Even if the end positions are not reached, the first motor 29 can be configured to switch off as soon as the motor current limit is reached in order to ensure protection against pinching.

Depending on the control of the worm gear motor 28, the support arm assembly 3 with the table top assembly 4 can be pivoted to any desired inclination position. No stop is required for the desired tilt adjustment between 0° and 90°. The self-locking of the worm gear motor 28 is sufficient. If necessary, however, stop means can also be provided for this purpose.

By now additionally referring in particular to FIGS. 4 and 5, it can be seen that the table top assembly 4 is pivotable about the pivot axis B relative to the support arm 6. For this purpose, the support arm 6 carries a pivot pin 42 at its second end 41 opposite the first end 27, on which a first end 43 of the table top assembly 4 is rotatably mounted. The table top assembly 4 can be pivoted between the folded position shown in FIG. 4, in which the holding arm 7 carrying the table top 8 is arranged substantially in line or coplanar with the support arm 6, and the unfolded position shown in FIG. 5, which is pivoted by substantially 90° relative to the folded position, so that the holding arm 7 and the table top 8 are aligned with their longitudinal extensions substantially perpendicular to the support arm 6, and vice versa. This pivoting of the table top assembly 4 about the second pivot axis B relative to the support arm 6 could, in principle, be performed manually by the user.

In the illustrated embodiment of the folding table arrangement 1 according to the present disclosure, however, the second drive device 13 with the second motor device 14 can advantageously be provided for driving and controlling the pivotal movement of the table top assembly 4 about the second pivot axis B. The second drive device 13 can then ensure an automated folding movement of the table top assembly 4 between the folded and the unfolded position in both directions of the folding movement.

As can be seen, the second drive device in the preferred embodiment shown is designed as a spindle drive device 45, which has a second motor 44, in particular an electric direct current motor, which belongs to the second motor device 14, a threaded spindle 46 driven in rotation by the second motor 44 and a spindle nut 47 cooperating with the threaded spindle 46. The spindle nut 47 is held non-rotatably but longitudinally displaceably on the support arm 6 and is guided linearly, and it cooperates with the threaded spindle 46 in order to convert a rotational movement of the threaded spindle 46 into a linear movement of the spindle nut 47. In addition, the spindle drive device 45 is operatively coupled between the holding arm 7 and the support arm 6 in such a way that a linear movement of the spindle nut 47 is converted into a pivotal movement of the table top assembly 4 about the second pivot axis B relative to the support arm 6. With the configuration according to the present disclosure, a simple, robust and effective linear drive can be provided to realize this pivotal movement.

Advantageously, the essential components of the linear drive are arranged on the support arm 6. The electric motor 44 is attached to the first end 27 of the support arm 6 and the threaded spindle 46 is rotatably mounted on the support arm 6. Furthermore, the spindle nut 47 is also mounted on the support arm 6 so as to be displaceable relative to the support arm, but non-rotatable. Advantageously, when setting up or stowing the folding table arrangement 1 according to the present disclosure, the electric motor 44, the threaded spindle 46 and the spindle nut 47 can be pivoted together with the support arm 6 and are not folded together with the table top assembly 4. In addition, the weight of the linear drive with the elements 44, 46, 47 can be distributed along the support arm 6 on both sides of the first pivot axis A, so that the weight is partially balanced. Thus, very low torques and drive forces of the first drive device 11 are sufficient to pivot the support arm 6 together with the second drive device 13, and also very low torques and drive forces of the second drive device 13 are sufficient to fold down the table top assembly 4. The first and second drive devices 11, 13 can therefore be designed for significantly lower torques or power, which means that their size can be reduced. A reduced size is very important in limited space conditions, such as those which may be found in vehicle interiors, living and office spaces, and many other areas of application.

The spindle nut 47 is attached to a bearing block 48, which is guided linearly on the holding arm 7 and can be moved along the support arm 6 together with the spindle nut 47. A joint 49 with a joint axis 51 is attached to the bearing block 48. The second drive device 13 also has a supporting beam 52, which is connected at one end via the joint 49 to the bearing block 48 and thus to the support arm 6 in a relatively pivotable manner. As a result, the supporting beam 52 is also drivingly connected to the spindle nut 47 via the joint 49 and is displaceably guided thereby along the support arm 6. At its other end, the supporting beam 52 is pivotally connected to the holding arm 7 of the table top assembly 4 via a further joint 53 and a further joint axis 54.

When the second motor device 14 rotates, the bearing block 48 with the spindle nut 47 is moved linearly via the threaded spindle 46, whereby it entrains the supporting beam 52 via the joint 49, so that the table top assembly 4 is folded or unfolded about the second pivot axis B depending on the direction of rotation of the electric motor 44 of the second motor device 14. The supporting beam 52 can pivot about the further pivot axis 54 relative to the holding arm 7 via the further joint 53 in order to achieve the folding-down movement. During the folding movement and in the fully unfolded position, the supporting beam 52 supports the holding arm 7 against the support arm 6 via the two joints 49, 53.

Preferably, the second motor 44 is configured in such a way that it switches off if predetermined maximum current limits of the motor current are exceeded when end positions are reached at which the spindle nut 47 is prevented from continuing to run. Even if the end positions are not reached, the electric motor 44 preferably switches off as soon as the motor current limit is reached in order to ensure protection against pinching.

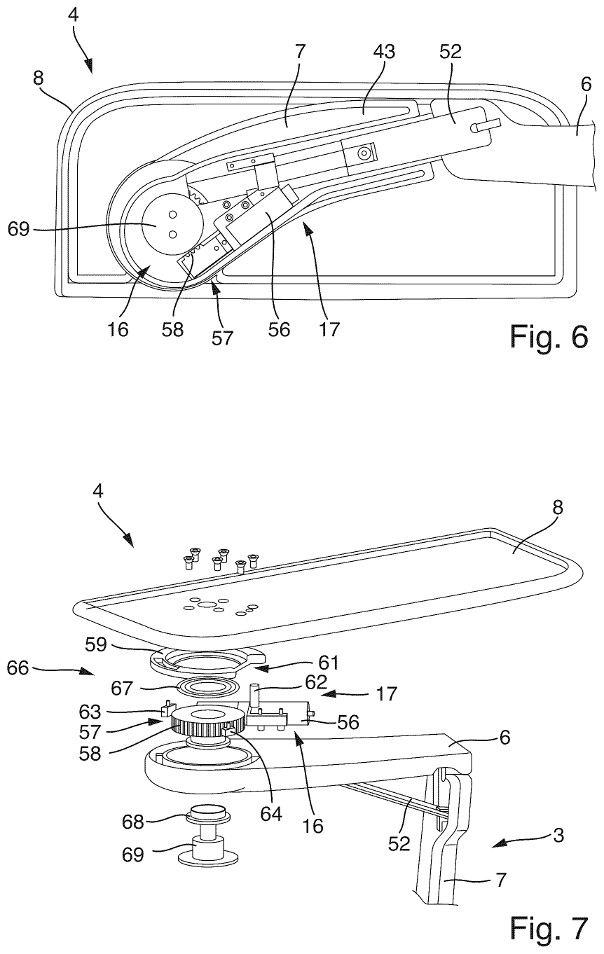

FIG. 6 shows the table top assembly 4 in the folded position (as in FIGS. 2a, 2b and 4), in which both the table top 8 and the supporting beam 52 extend substantially parallel to the support arm 6, while FIG. 5 shows the table top assembly 4 in the unfolded position (as in FIGS. 1, 2c, 2d), in which the table top 8 is oriented substantially perpendicular to the support arm 6 and the supporting beam 52 is oriented at an angle to the table top assembly 4 and the support arm 6 to form a cross brace and support the table top assembly 4 against the support arm 6.

Referring now in particular to FIGS. 6 and 7, the third drive device 16 with the third motor device 17 for driving and controlling the rotational movement of the table top 8 about the rotational axis C relative to the holding arm 7 is described in more detail below. In FIGS. 6 and 7, the spindle drive device 45 of the second drive device 13 is omitted for the sake of simplicity and clarity in order to illustrate the components of the third drive device 16 more clearly. In principle, a rotational movement of the table top 8 could also be carried out manually, although the motor-assisted rotational movement of the table top 8 is preferred because it offers additional comfort and, together with either the first and/or the second drive device 11, 13, enables a largely semi-automated or even fully automated, electrically operated setting of the folding table arrangement 1 into the use position or into a position suitable for stowing in a storage space.

In the embodiment shown, the third motor device 17 has a third motor 56, in particular an electric motor or worm gear motor, with a third or further worm gear 57. The third/further worm gear 57 is designed to be self-locking in the preferred embodiment shown here.

It should be noted that the terms “first”, “second”, “third”, etc. used herein do not indicate any order or importance of the elements disclosed, but rather are used to distinguish one element from one or more other similar or identical elements and to facilitate reference. The description of a “second” element or a “third” element or the like also does not imply the presence of a “first” such element or both a “first” and a “second” such element, or the like.

Referring now in particular to FIG. 7, the table top assembly 4 with the third drive device 16 is shown there in an exploded view with its components in detail. In particular, the table top assembly 4 can include the holding arm 7, the table top 8 and the third motor 56 with the third worm gear 57, which comprises a worm wheel 58. The table top assembly 4 here further comprises a ring 59, which is attached to the underside of the table top 8 and has an end position latching device 61, which provides mechanical end stops for the end positions offset by 180° for the rotation of the table top 8. An associated latching bolt 62, which cooperates with the end position latching device 61 to define the end positions, may be rigidly attached to the holding arm 7 together with the third motor 56.

Furthermore, a first switch 63 and a second switch 64 may be provided for the rotational end positions of the table top 8 when the table top 8 is rotated by a motor. The end position switches 63, 64 can be arranged on the ring 59 and thus on the table top 8 at positions offset by 180° with respect to the rotational axis C. The first switch 63 can be assigned to the turned-in end position of the table top 8, while the second switch 64 can be assigned to the turned-out end position rotated by 180°. When the folding table arrangement 1 is operated electrically, the table top 8 is rotated via the third worm gear 57 until one of the first end position switch 63 and the second end position switch 64 is reached. The respective end position switch 64, 64 can then supply an electrical signal to the control unit, which indicates that the respective rotational end position has been reached, whereupon the control unit can stop the third motor 56. The end position detection could also be accomplished by optical sensors, magnetic sensors (in particular Hall sensors), electrical sensors or other sensor means.

In the preferred embodiment of the folding table arrangement 1 according to the present disclosure shown, a slipping clutch 66 is arranged between the worm wheel 58 of the third worm gear 57 and the table top 8. The slipping clutch 66 makes it possible to manually rotate the table top 8 relative to the worm wheel 58 of the third worm gear 57 by applying an external force. When the table top 8 is rotated by a motor, a person can apply a force with a certain minimum load to the table in order to stop the table top 8 or even rotate it in the opposite direction to the direction of rotation of the third motor 56. This can prevent a passenger from being injured or at least reduce the risk of injury in the event of motor actuation or other impact caused by a collision between the passenger and the table top 8. This also provides anti-pinch protection. In addition, the passenger can quickly set or adjust the rotational position of the table by hand at any time.

In the embodiment shown, the slipping clutch 66 comprises two O-rings 67, which are interposed and lightly clamped as a damping device between the table top 8 and the worm wheel 58 of the third worm gear 57. The worm wheel 58 is rotatably mounted on a slide bearing 68, which is held by a bolt 69. The bolt 69 is screwed to the table top 8 in abutment, and the worm wheel 58 can rotate freely on or relative to the bolt 69. When the worm wheel 58 rotates, the table top 8 is carried along by the O-rings 67, which are used for damping. However, the passenger has the option of stopping the table top 8 or continuing to adjust it manually.

The folding table arrangement 1 described so far operates as follows:

It is assumed that the folding table arrangement 1 is in the state shown in FIG. 2a, in which the support arm assembly 3 is fully retracted, the table top assembly 4 is folded in and the table top 8 is folded closed and rotated into a basic position. If the folding table arrangement 1 is now to be transferred into the use position, the passenger can press a suitable control means, in the simplest case a button on a control panel or controller, in order to initiate an automatically set-up process for the folding table arrangement 1 into the position of use. A control system, which is not shown in detail here, then controls the first drive unit 11, the second drive unit 13 and the third drive unit 16 in a suitable manner in order to carry out the set-up process.

The first drive device 11 extends the support arm assembly 3 into the fully extended position shown in FIG. 2b, in which the support arm assembly 3 projects substantially vertically upwards. The worm gear motor 28, in conjunction with the gearwheel gear unit 36, ensures a smooth, trouble-free extension process at the desired speed. Advantageously, the second motor 44 of the second motor device 14, the threaded spindle 46 and the spindle nut 47 with the bearing block 48 and other associated guide and fastening elements are pivoted together with the support arm assembly 3 with little additional torque required.

The second drive device 13 folds out the table top assembly 4 into the unfolded position shown in FIG. 2c, in which the table top 8 lies in a substantially horizontal plane. Advantageously, only the end of the supporting beam 52 hinged to the holding arm 7 is folded down together with the table top assembly, while the other components of the second drive device 13 do not perform this folding-down movement. The electric motor 44 and the threaded spindle drive can be designed for significantly lower loads than in a configuration in which the second drive device 13 is attached to the holding arm 7. However, the latter configuration is also possible in principle.

The third drive device 16 rotates the table top 8 by motor from the rotational position shown in FIG. 2c to the rotational position shown in FIG. 2d, which is rotated by 180°. In this position, if the table top 8 has two foldable table top halves 8a, 8b, a user can then fold open the table top halves to create a table top 8 with an enlarged table surface area, as illustrated in FIG. 1.

If required, the table top 8 could also be brought into a slightly inclined position. For this purpose, any desired inclination of the support arm 6 and/or the table top assembly 4 can be set up by motor. Any desired rotational position of the table top 8 can also be set by motor. The rotational position of the table top 8 can also be adjusted manually at any time via the slipping clutch 66.

If the folding table arrangement 1 is to be stowed away again in a storage space, for example in a rear seat console of a motor vehicle or a housing, the drive devices 11, 13, 16 are operated by the control device in the opposite direction when controlled or triggered by the user in order to automatically rotate and fold in the folding table arrangement 1 and retract it into the position shown in FIG. 2a.

Advantageously, the setting up and stowing of the folding table arrangement 1 in the particularly preferred embodiment shown can be accomplished in a completely automated and controlled manner by the drive devices 11, 13 and 16. The risk of incorrect operation of the folding table arrangement 1 and the risk of damage to components of the folding table arrangement 1 or the surroundings or injury to the operator is virtually non-existent. The motor-assisted folding table arrangement 1 is characterized by its ease of use and high level of comfort with a relatively simple design, very small installation space and low weight. It is quick and easy to set up and stow away, can be used flexibly, is robust and durable.

It should be noted that the individual operations of extending the support arm assembly 3, unfolding the table top assembly 4 and rotating the table top 8 have been described here as sequential, one after the other, for the sake of simplicity and illustration only. The control system of the folding table arrangement 1 according to the present disclosure can advantageously be implemented in such a way that it operates the first, second and third drive devices 11, 13, 16 largely in parallel in order to carry out the extending or retracting movement of the support arm assembly 3, the folding or unfolding movement of the table top assembly 4 and the rotational movement of the table top 8 as parallel as possible and at the same time. For example, the control system can instruct the second drive device 13 and the third drive device 16 to fold and rotate the table top assembly largely in parallel and simultaneously as soon as or as long as the support arm assembly 3 is sufficiently outside a storage space so that these folding and rotating movements are permitted. This enables very fast processes for setting up or stowing the folding table arrangement 1 with coordinated, smooth movements of all components, which additionally contributes to the appealing aesthetics of the folding table arrangement 1 according to the present disclosure.

Numerous modifications are possible within the scope of the present disclosure. For example, the base carrier 2 can be designed to suit different requirements and installation environments. The gear transmission device 36 can also be of a different design, in particular multi-stage, with more than two gear transmission elements, as a planetary gear, worm gear or the like. The gear element 38 could also be designed as a full wheel. However, the single-stage gear transmission device 36 used here with the pinion 37 and the gear segment 39 is preferred due to its very small space requirement, its simple and robust design and its reliable operation.

The folding table arrangement 1 can be designed and used flexibly. In particular, the degree of automation in setting up and stowing the folding table arrangement 1 can be realized in different ways depending on desires and requirements. For example, in an advantageous, simplified embodiment, only the first drive device 11 for pivoting about the first pivot axis A can be provided, while the second drive device 13 for the second pivot axis B can be omitted. The extension and retraction of the support arm assembly 3 is then motor-driven, while the folding down of the table top assembly 4 is done manually. For example, instead of the threaded spindle 46 and the spindle nut 47, a guide sleeve displaceable on a linear shaft, a sliding carriage on a slide rail or another linear guide can be provided either on the holding arm 7 or on the support arm 6, to which a supporting beam, for example the supporting beam 52, can be pivotally connected at one end, while the other end of the supporting beam can be pivotally connected to the other end of the holding arm 7 or the support arm 6. Means for locking the support arm in the position of use should be provided. In addition to the first drive device 11, the motor-assisted third drive device 16 can be provided for rotating the table top 8 about the rotational axis C. Alternatively, this can be omitted and the table top 8 can be rotated manually.

In a further advantageous, simplified embodiment, only the second drive device 13 can be provided for pivoting about the second pivot axis B, while the first drive device 11 for the first pivot axis A can be omitted. The extension and retraction of the support arm assembly 3 is then carried out manually, while the folding of the table top assembly 4 is motorized and automated. In this respect, the first motor 29, in particular the worm gear motor 28, can be omitted. The gear transmission device 36 can be provided in the embodiment shown or in another form, e.g. in the form of a planetary gear, to guide the extension and retraction movement. The gear mechanism 36 can also be omitted and replaced by a suitable pivot bearing. Locking means should be provided to fix a set inclination position of the support arm 6. In addition to the second drive device 13, the motor-assisted third drive device 16 can be provided for rotating the table top 8 about the rotational axis C. Alternatively, this can be omitted and the table top 8 can be rotated manually.

An electrically operated folding table arrangement 1 has a base carrier 2, a support arm assembly 3 coupled to the base carrier 2 and having a support arm 6 pivotally mounted about a first pivot axis A, and a table top assembly 4 coupled to the support arm 3 and pivotable relative to the support arm 3 about a second pivot axis B. The table top assembly 4 comprises a holding arm 7 hinged to the support arm 6 and a table top 8 rotatably mounted on the holding arm 7 about a rotational axis C. The table top assembly 4 is assigned a drive device 13 which has a motor device 13 for driving and controlling the pivoting movement of the table top assembly 4 about the second pivot axis B relative to the support arm 6, wherein the drive device 13 has a spindle drive device 45 and the spindle drive device 45 is mounted on the support arm 6 so that it is pivotable together with the support arm 6. At least one further motor-assisted drive device 11, 16 can be provided for driving and controlling the pivoting movement of the support arm assembly 3 about the first pivot axis A and/or the rotational movement of the table top 8 about the rotational axis C.

1. A folding table arrangement, comprising:
a base carrier;
a support arm assembly coupled to the base carrier and having a support arm which is pivotally mounted about a first pivot axis and pivotable between a retracted position and an extended position; and
a table top assembly coupled to the support arm and pivotally arranged relative to the support arm about a second pivot axis different from the first pivot axis, wherein the table top assembly is pivotable between a folded position and an unfolded position,
the table top assembly comprising a holding arm hinged to the support arm and a table top rotatably mounted on the holding arm about a rotational axis different from the first pivot axis and the second pivot axis, and
wherein the table top assembly is assigned a drive device which has a motor device for driving and controlling the pivoting movement of the table top assembly about the second pivot axis relative to the support arm, wherein the drive device comprises a spindle drive device and the spindle drive device is mounted on the support arm so that it is pivotable together with the support arm.

2. The folding table arrangement according to claim 1, wherein the spindle drive device comprises a motor, which is part of the motor device, a threaded spindle driven in rotation by the motor and a spindle nut which cooperates with the threaded spindle in order to convert a rotational movement of the threaded spindle into a linear movement of the spindle nut, wherein the spindle drive device is operatively coupled between the holding arm and the support arm in such a way that a linear movement of the spindle nut is converted into a pivotal movement of the table top assembly about the second pivot axis relative to the support arm.

3. The folding table arrangement according to claim 2, wherein the motor is attached to the support arm, the threaded spindle is rotatably mounted on the support arm and the spindle nut is non-rotatably connected to the support arm and is displaceably mounted relative to the support arm.

4. The folding table arrangement according to claim 3, wherein the drive device comprises a supporting beam which is connected at one end to the support arm via a joint so as to be relatively pivotable and displaceable, wherein the supporting beam is drivingly connected via the joint to the spindle nut in order to be displaced by the latter along the support arm, wherein the supporting beam is hinged at its other end to the holding arm of the table top assembly via a further joint.

5. The folding table arrangement according to claim 2, wherein the motor is arranged to switch off if predetermined maximum current limits for the motor current are exceeded when end positions are reached.

6. The folding table arrangement according to claim 1, wherein the support arm assembly is furthermore assigned a further drive device which has a further motor device and a gear transmission device drivingly connected to the further motor device for driving and controlling the pivoting movement of the support arm about the first pivot axis relative to the base carrier.

7. The folding table arrangement according to claim 6, wherein the further motor device is designed as a worm gear motor with a first motor and a self-locking worm gear.

8. The folding table arrangement according to claim 6, wherein the gear transmission device comprises a pinion driven by the further motor device and a gear element which is fixedly connected to the support arm and meshes with the pinion.

9. The folding table arrangement according to claim 8, wherein the gear element is designed as a gear segment which is limited by an angular range which is greater than or equal to 90° and less than 120°, preferably less than 110°, particularly preferably less than 100°.

10. The folding table arrangement according to claim 8, wherein the gear transmission device is designed as a spur gearing, wherein the pinion and the gear element are designed as straight teethed spur gears.

11. The folding table arrangement according to claim 6, wherein the gear transmission device forms a single-stage transmission and enables a transmission to slow speed.

12. The folding table arrangement according to claim 6, wherein the further motor device is arranged to switch off if predetermined maximum current limits for a current of the further motor device are exceeded when end positions are reached.

13. The folding table arrangement according to claim 1, wherein the table top assembly has a third drive device comprising a third motor device for driving and controlling rotational movement of the table top about the rotational axis relative to the holding arm.

14. The folding table arrangement according to claim 13, wherein the third drive device comprises a third motor with a self-locking worm gear.

15. The folding table arrangement according to claim 13, wherein a slipping clutch is arranged in a power transmission path of the third drive device between the third motor device and the table top in order to allow the table top to be rotated relative to the third motor device by an external force.

16. The folding table arrangement according to claim 15, wherein the slipping clutch comprises a damping device which preferably comprises at least one O-ring interposed between the third motor device and the table top.

17. The folding table arrangement according to claim 13, wherein the third drive device comprises at least one end position switch.

18. The folding table arrangement according to claim 9, wherein the angular range which is less than 110° or less than 100°.

19. The folding table arrangement according to claim 4, wherein the motor is arranged to switch off if predetermined maximum current limits for a current of the motor are exceeded when end positions are reached.

20. The folding table arrangement according to claim 19, wherein the support arm assembly is furthermore assigned a further drive device which has a further motor device and a gear transmission device drivingly connected to the further motor device for driving and controlling the pivoting movement of the support arm about the first pivot axis relative to the base carrier.
